(19) United States
(12) Patent Application Publication
(10) Pub. No.: US 2026/0048721 A1
(43) Pub. Date: Feb. 19, 2026

(54) SIGNAL PROCESSING DEVICE

(71) Applicant: DENSO CORPORATION, Kariya-city (JP)

(72) Inventor: Kazuhiro YOSHIDA, Kariya-city (JP)

(21) Appl. No.: 19/365,552

(22) Filed: Oct. 22, 2025

Related U.S. Application Data
(63) Continuation of application No. PCT/JP2024/011430, filed on Mar. 22, 2024.

(30) Foreign Application Priority Data
Apr. 25, 2023 (JP) 2023-071628

(51) Int. Cl. B60T 7/04; B60T 7/06; G05G 5/03

(52) U.S. Cl. CPC B60T 7/042; B60T 7/06; G05G 5/03; B60T 2220/04; B60T 2270/82

(57) ABSTRACT

A signal processing device for processing a sensor signal output from a sensor of a brake pedal device includes a behavior determination unit, a filter circuit and a filter constant setting unit. The behavior determination unit determines, based on the sensor signal, whether a bouncing behavior occurs after a pedal arm rotates in a closing direction and reaches a fully closed position. The filter circuit performs smoothing processing on the sensor signal in accordance with a filter constant to generate a control signal for braking the vehicle, and the larger the filter constant, the greater the smoothing degree of the change in the sensor signal that is generated. The filter constant setting unit sets the filter constant when the behavior determination unit determines that the bouncing behavior occurs to be larger than the filter constant when the behavior determination unit determines that the bouncing behavior does not occur.

### CROSS REFERENCE TO RELATED APPLICATIONS

This application is a continuation application of International Patent Application No. PCT/JP2024/011430 filed on Mar. 22, 2024, which designated the U.S. and based on and claims the benefits of priority of Japanese Patent Application No. 2023-071628 filed on Apr. 25, 2023. The entire disclosure of all of the above applications is incorporated herein by reference.

### TECHNICAL FIELD

The present disclosure relates to a signal processing device for use in a brake-by-wire system.

### BACKGROUND ART

Conventionally, in a brake-by-wire system, an electronic control unit controls vehicle braking based on an electrical signal output from a brake pedal device mounted on a vehicle.

### SUMMARY

An object of the present disclosure is to improve drivability at low cost without increasing the size of a brake pedal device in a signal processing device used in a brake-by-wire system.

According to one aspect of the present disclosure, a signal processing device is used in a brake-by-wire system and processes a sensor signal output from a sensor of a brake pedal device. The brake pedal device includes a support member, a pedal arm, a spring mechanism, a full-close stopper, and a sensor. The sensor outputs a sensor signal corresponding to an angle or a stroke amount of the pedal arm. The signal processing device that processes the sensor signal includes a behavior determination unit, a filter circuit, and a filter constant setting unit. The behavior determination unit determines, based on the sensor signal, whether a bouncing behavior occurs after the pedal arm rotates in the closing direction and reaches the fully closed position. The filter circuit performs smoothing processing on the sensor signal in accordance with a filter constant to generate a control signal for braking the vehicle, and the larger the filter constant, the greater the smoothing degree of the change in the sensor signal that is generated. The filter constant setting unit sets the filter constant when the behavior determination unit determines that the bouncing behavior will occur to be larger than the filter constant when the behavior determination unit determines that the bouncing behavior will not occur.

According to another aspect of the present disclosure, a signal processing device is used in a brake-by-wire system and processes a sensor signal output from a sensor of a brake pedal device. The sensor outputs a sensor signal corresponding to an angle or a stroke amount of the pedal arm. The signal processing device that processes the sensor signal includes a behavior determination unit and a signal switching unit. The behavior determination unit determines, based on the sensor signal, whether or not a bouncing behavior occurs after the pedal arm rotates in the closing direction and reaches the fully closed position. When the behavior determination unit determines that bouncing behavior will occur, the signal switching unit switches and outputs a control signal for braking the vehicle to a signal value indicating that the pedal arm is in a fully closed position for a predetermined period of time.

### BRIEF DESCRIPTION OF THE DRAWINGS

FIG. 1 is a schematic configuration diagram of a brake-by-wire system in which a signal processing device according to a first embodiment is used;

FIG. 2 is a block diagram of an electronic control unit incorporating the signal processing device according to the first embodiment;

FIG. 3 is a flowchart showing a control process executed by the signal processing device according to the first embodiment;

FIG. 4 is a graph showing a relationship between a sensor signal and a control signal in the signal processing device according to the first embodiment;

FIG. 5 is a graph showing a relationship between a sensor signal and a control signal in a signal processing device of a comparative example;

FIG. 6 is a block diagram of an electronic control unit incorporating a signal processing device according to a second embodiment;

FIG. 7 is a block diagram of an electronic control unit incorporating the signal processing device according to the second embodiment;

FIG. 8 is a flowchart showing a control process executed by the signal processing device according to the second embodiment;

FIG. 9 is a graph showing the relationship between a sensor signal and a control signal in the signal processing device according to the second embodiment;

FIG. 10 is a graph showing a relationship between a sensor signal and a control signal, and a movement speed of a pedal arm in a signal processing device according to a third embodiment;

FIG. 11 is a graph showing a relationship between a sensor signal and a control signal, and a staying time at the fully closed position of the pedal arm in a signal processing device according to a fourth embodiment;

FIG. 12 is a graph showing a relationship between a sensor signal and a control signal, a movement speed of a pedal arm, and an acceleration of the movement of the pedal arm in a signal processing device according to a fifth embodiment;

FIG. 13 is a graph showing a relationship between the angle or stroke of the pedal arm and the applied force acting on the pedal arm from the spring mechanism in the signal processing device according to the fifth embodiment;

FIG. 14 is a graph showing a relationship between a sensor signal and a control signal in a signal processing device according to a sixth embodiment;

FIG. 15 is a schematic configuration diagram of a brake-by-wire system in which a signal processing device according to a seventh embodiment is used;

FIG. 16 is a graph showing a relationship between a sensor signal and a control signal, and an output value of a load sensor in the signal processing device according to the seventh embodiment; and

FIG. 17 is a schematic configuration diagram of a brake-by-wire system in which a signal processing device according to an eighth embodiment is used.

### DETAILED DESCRIPTION

In an assumable example, in a brake-by-wire system, an electronic control unit controls vehicle braking based on an electrical signal output from a brake pedal device mounted on a vehicle. Also, in the accelerator-by-wire system, an electronic control unit controls the acceleration and deceleration of a vehicle based on an electrical signal output from an accelerator pedal device. An accelerator pedal device is used in an accelerator-by-wire system. The accelerator pedal device includes a pedal arm that rotates in response to a force applied by the driver, a spring mechanism that applies a reaction force against the force to the pedal arm, and two fully closed stoppers that stop the pedal arm in a fully closed position. The fully closed position is a position in which the rotation of the pedal arm is restricted when no pedal force is being applied by the driver to the pedal arm, and is called a rest position. Furthermore, the fully closed stopper is called a pause stopper. The accelerator pedal device is provided with two fully closed stoppers to suppress the collision noise that occurs when the pedal arm rotates forcefully due to the applied force of the spring mechanism and collides with the fully closed stopper when the driver releases his/her foot from the pedal arm.

However, when the driver removes his/her foot from the pedal arm, if the applied force caused by the spring mechanism to cause the pedal arm to collide with the fully closed stopper is large, the pedal arm may bounce back near the fully closed position. In this case, the sensor signal output from the sensor of the accelerator pedal device also oscillates near the fully closed position. Therefore, when the electronic control unit controls the acceleration/deceleration of the vehicle based on the sensor signal, the vehicle will be accelerated or decelerated against the driver's will to release the accelerator, resulting in a problem of deterioration of drivability. The problem of deterioration of drivability due to such a bouncing behavior of the pedal arm is not limited to the accelerator-by-wire system, but can also occur in the brake-by-wire system.

In general, the applied force of the spring mechanism included in the brake pedal device used in the brake-by-wire system is greater than the applied force of the spring mechanism included in the accelerator pedal device. Therefore, in the brake pedal device, when the driver releases his/her foot from a state in which the pedal arm is depressed, the impact force when the pedal arm collides with the fully closed stopper is greater than in an accelerator pedal device, and the bouncing behavior of the pedal arm becomes greater. In this case, the sensor signal output from the sensor of the brake pedal device also vibrates significantly near the fully closed position. Therefore, when the electronic control unit applies the brakes on the basis of the sensor signal, the vehicle will be braked against the driver's will to release the brakes, resulting in a problem of deterioration of drivability.

Furthermore, in the brake-by-wire system, when the electronic control unit brakes the vehicle in response to a sensor signal that vibrates in accordance with the bouncing behavior of the pedal arm, the number of unnecessary operations for vehicle braking increases, which can lead to problems such as accelerated wear on the brake pads, etc.

In order to solve these problems, it is conceivable to set a large filter constant for a filter circuit that performs smoothing processing on a sensor signal output from a sensor in the signal processing device used in the brake-by-wire system. However, when the filter constant is set to a large value, and the driver depresses and releases the pedal arm, the response of the vehicle braking is delayed, resulting in a deterioration in drivability.

Also, in order to prevent the pedal arm from bouncing back, it is conceivable to increase the size of the fully closed stopper and physically absorb the impact force of the pedal arm. However, when the size of the fully closed stopper is increased, the brake pedal device will also increase in size, which raises concerns about increased manufacturing costs.

An object of the present disclosure is to improve drivability at low cost without increasing the size of a brake pedal device in a signal processing device used in a brake-by-wire system.

According to one aspect of the present disclosure, a signal processing device is used in a brake-by-wire system and processes a sensor signal output from a sensor of a brake pedal device. The brake pedal device includes a support member, a pedal arm, a spring mechanism, a full-close stopper, and a sensor. The support member is attached to a vehicle. The pedal arm is rotatably provided around a predetermined axis relative to the support member, and rotates in an opening direction when a driver's pedal force increases and rotates in a closing direction when the driver's pedal force decreases or is released. The spring mechanism applies a biasing force to the pedal arm as a reaction force against the driver's pedal force. The full-close stopper stops the pedal arm at a fully closed position where the rotation of the pedal arm in the closing direction is restricted when the pedal force of the driver is not being applied to the pedal arm. The sensor outputs a sensor signal corresponding to an angle or a stroke amount of the pedal arm. The signal processing device that processes the sensor signal includes a behavior determination unit, a filter circuit, and a filter constant setting unit. The behavior determination unit determines, based on the sensor signal, whether or not a bouncing behavior occurs after the pedal arm rotates in the closing direction and reaches the fully closed position. The filter circuit performs smoothing processing on the sensor signal in accordance with a filter constant to generate a control signal for braking the vehicle, and the larger the filter constant, the greater the smoothing degree of the change in the sensor signal that is generated. The filter constant setting unit sets the filter constant when the behavior determination unit determines that the bouncing behavior will occur to be larger than the filter constant when the behavior determination unit determines that the bouncing behavior will not occur.

According to this configuration, when the behavior determination unit determines that a bouncing behavior will occur, the filter constant setting unit sets the filter constant to a large value, and the filter circuit generates a control signal that greatly smooths the change in the sensor signal. Therefore, even if the driver removes his/her foot from the pedal arm while it is depressed and the pedal arm bounces back, the electronic control unit of the brake-by-wire system instantly releases the vehicle braking based on the control signal in which the change in the sensor signal has been significantly smoothed, thereby improving drivability.

On the other hand, when the behavior determination unit determines that no bouncing behavior occurs, the filter constant setting unit sets the filter constant to a value smaller than that when bouncing behavior will occur, and the filter circuit generates a control signal that smooths the change in the sensor signal to a small degree. Therefore, when the driver depresses and releases the pedal with his/her foot on the pedal arm, the electronic control unit of the brake-by-wire system performs vehicle braking with high response based on a control signal with a small degree of smoothing of change in the sensor signal, thereby improving drivability.

In addition, according to the signal processing of this signal processing device, even if the pedal arm bounces back, the electronic control unit immediately releases the vehicle braking command, so there is no unnecessary increase in the number of operations for vehicle braking and unnecessary wear on the brake pads, etc. can be prevented.

Furthermore, according to the signal processing of this signal processing device, even if the biasing force of the spring mechanism of the brake pedal device is increased, there is no need to increase the size of the full-close stopper that physically absorbs the collision force of the pedal arm, and drivability can be improved through control. Therefore, an increase in size of the brake pedal device due to an increase in the size of the full-close stopper can be prevented, and manufacturing costs can be reduced.

According to another aspect of the present disclosure, a signal processing device is used in a brake-by-wire system and processes a sensor signal output from a sensor of a brake pedal device. The brake pedal device includes a support member, a pedal arm, a spring mechanism, a full-close stopper, and a sensor. The support member is attached to a vehicle. The pedal arm is rotatably provided around a predetermined axis relative to the support member, and rotates in an opening direction when a driver's pedal force increases and rotates in a closing direction when the driver's pedal force decreases or is released. The spring mechanism applies a biasing force to the pedal arm as a reaction force against the driver's pedal force. The full-close stopper stops the pedal arm at a fully closed position where the rotation of the pedal arm in the closing direction is restricted when the pedal force of the driver is not being applied to the pedal arm. The sensor outputs a sensor signal corresponding to an angle or a stroke amount of the pedal arm. The signal processing device that processes the sensor signal includes a behavior determination unit and a signal switching unit. The behavior determination unit determines, based on the sensor signal, whether or not a bouncing behavior occurs after the pedal arm rotates in the closing direction and reaches the fully closed position. When the behavior determination unit determines that bouncing behavior will occur, the signal switching unit switches and outputs a control signal for braking the vehicle to a signal value indicating that the pedal arm is in a fully closed position (hereinafter referred to as a “full-close signal”) for a predetermined period of time.

According to this configuration, when the behavior determination unit determines that a bouncing behavior will occur, the signal switching unit switches the control signal to a full-close signal for a predetermined period of time and outputs it. Therefore, even if the driver removes his/her foot from the pedal arm and the pedal arm bounces back, the electronic control unit of the brake-by-wire system instantly releases the vehicle brakes based on a full-close signal, thereby improving drivability.

On the other hand, when the behavior determination unit determines that the bouncing behavior will not occur, the signal switching unit does not switch the control signal to the full-close signal. Therefore, when the driver depresses and releases the pedal with his/her foot on the pedal arm, the electronic control unit of the brake-by-wire system performs vehicle braking with high responsiveness based on the control signal or the sensor signal that is normally processed, thereby improving drivability.

In addition, according to the signal processing of the signal processing device according to another aspect of the present disclosure, as in one aspect of the present disclosure, there is no unnecessary increase in the number of operations for vehicle braking, and unnecessary wear of brake pads, etc. can be prevented.

Furthermore, according to the signal processing of the signal processing device according to another aspect of the present disclosure, as with one aspect of the present disclosure, there is no need to increase the size of the fully closed stopper, thereby preventing the brake pedal device from becoming larger and reducing manufacturing costs.

Embodiments of the present disclosure will now be described with reference to the drawings. Parts that are identical or equivalent to each other in the following embodiments are assigned the same reference numerals and will not be described.

### First Embodiment

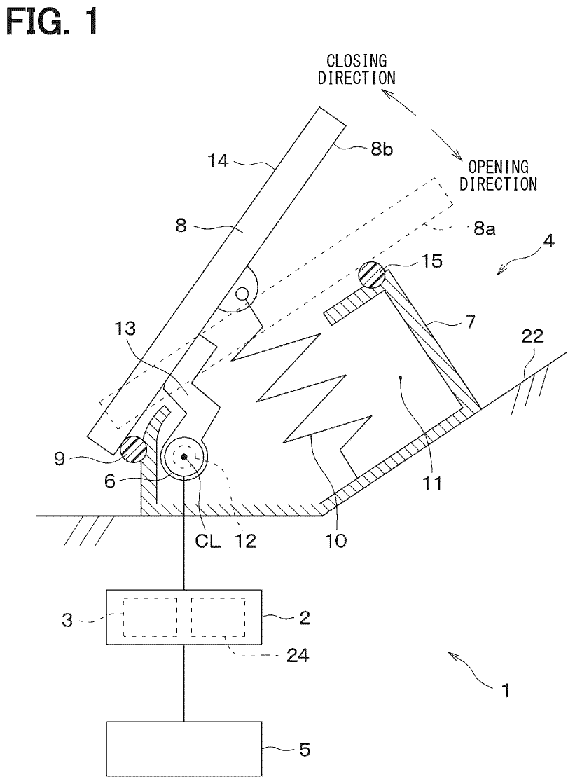

A first embodiment will be described with reference to the drawings. As shown in FIG. 1, in the first embodiment, a signal processing device 3 is incorporated into a part of an electronic circuit of an electronic control unit 2 used in a brake-by-wire system 1 that performs vehicle braking. Hereinafter, the electronic control unit 2 will be referred to as “ECU 2.” ECU is an abbreviation of Electronic Control Unit. The signal processing device 3 is not limited to being incorporated in the ECU 2, but may be configured as an integrated circuit such as an IC or ASIC integrated with the sensor 6 provided in the brake pedal device 4.

First, a schematic configuration of the brake-by-wire system 1 will be described.

As shown in FIG. 1, the brake-by-wire system 1 includes a brake pedal device 4, an ECU 2, a brake mechanism 5, and the like. The brake-by-wire system 1 is a system in which an ECU 2 controls the operation of a brake mechanism 5 based on a sensor signal output from a sensor 6 provided in the brake pedal device 4 to perform vehicle braking. In particular, the brake-by-wire system 1 in which the signal processing device 3 of the first embodiment is used is a complete brake-by-wire system in which components of the brake mechanism 5 (e.g., a master cylinder) and the brake pedal device 4 are not mechanically connected.

The brake pedal device 4 includes a housing 7 as a support member, a pedal arm 8, a full-close stopper 9, a spring mechanism 10, a sensor 6, and the like. FIG. 1 shows a cross-sectional view of the brake pedal device 4.

The housing 7 of the brake pedal device 4 is fixed to the vehicle by bolts or the like (not shown). Specifically, the housing 7 is fixed to the floor 22 or dash panel inside the vehicle compartment. An internal space 11 is provided inside the housing 7. The internal space 11 accommodates the sensor 6, the spring mechanism 10, the shaft 12, and the like. The sensor 6 is disposed at a position overlapping the shaft 12 in the axial direction thereof. Therefore, the shaft 12 is provided on a rear side of the paper surface of FIG. 1 with respect to the sensor 6. The shaft 12 is rotatably provided relative to the housing 7 around its own axis CL.

The pedal arm 8 is formed in a substantially plate-like shape and is fixed to the shaft 12 via a connecting member 13. The connecting member 13 has one end fixed to a lower surface of the pedal arm 8 and the other end fixed to the shaft 12. Therefore, the pedal arm 8 is provided to be rotatable with respect to the housing 7 around the axis CL of the shaft 12.

The brake pedal device 4 of the first embodiment is an organ-type pedal device. An organ-type pedal device refer to a device configured such that all or most of the pedal tread surface 14, which is the part of the pedal arm 8 to which the driver's pedal force is applied, is disposed above the rotation axis CL of the pedal arm 8 in the vertical direction when mounted on the vehicle, that is, above the vehicle. In the organ-type pedal device, the pedal arm 8 rotates toward the floor 22 or dash panel in the vehicle compartment in response to an increase in the pedal force applied to the pedal arm 8 by the driver.

In the following description, a direction in which the pedal arm 8 rotates due to an increase in the driver's pedal force applied to the pedal arm 8 is referred to as an opening direction, and a direction in which the pedal arm 8 rotates due to a decrease or release of the driver's pedal force applied to the pedal arm 8 is referred to as a closing direction. The opening direction is called a pedal depression direction, and the closing direction is called a pedal return direction.

The rotation of the pedal arm 8 in the opening direction is restricted by a full-open stopper 15. The full-open stopper 15 is a member that stops the pedal arm 8 at a fully open position where the rotation of the pedal arm 8 in the opening direction is restricted when the pedal force of the driver is applied to the pedal arm 8. A dashed line 8a in FIG. 1 indicates a state in which the pedal arm 8 and the full-open stopper 15 abut against each other and the pedal arm 8 is in the fully open position. The full-open stopper 15 is preferably made of an elastic material such as rubber, resin, or silicone.

On the other hand, the rotation of the pedal arm 8 in the closing direction is restricted by a full-close stopper 9. The full-close stopper 9 is a member that stops the pedal arm 8 at a fully closed position where the rotation of the pedal arm 8 in the closing direction is restricted when the pedal force of the driver is not being applied to the pedal arm 8. A solid line 8b in FIG. 1 indicates a state in which the pedal arm 8 and the full-close stopper 9 abut against each other and the pedal arm 8 is in the fully closed position. Incidentally, the full-close stopper 9 is also preferably made of an elastic material such as rubber, resin, or silicone.

The spring mechanism 10 is configured to include one or more springs. The spring mechanism 10 is a mechanism that generates an applied force that acts as a reaction force against the pedal force applied to the pedal arm 8 by the driver. By equipping the brake pedal device 4 with the spring mechanism 10, even if the mechanical connection between the pedal arm 8 and the conventional master cylinder is eliminated, it is possible to obtain a reaction force similar to that obtained when connected to a master cylinder, i.e., when the reaction force is obtained by hydraulic pressure.

The sensor 6 detects the pedal arm 8 or the shaft 12 and outputs a sensor signal according to the angle or stroke amount of the pedal arm 8 as the pedal arm 8 or the shaft 12 is the detection target. As the sensor 6, various types of sensors can be used, such as a magnetic sensor, an inductive sensor, an optical sensor, a load sensor, a rotary encoder, and a potentiometer. The sensor 6 is not limited to being provided at a position overlapping the axis CL of the shaft 12, but may be provided at a position away from the axis CL. The sensor signal output from the sensor 6 is transmitted to the ECU. In this specification, the sensor signal refers to the “sensor raw value” output from the sensor 6.

The ECU 2 includes a microcontroller having a processor for performing control processing and arithmetic processing, and a storage unit, such as a ROM and a RAM, for storing programs and data. The controller also includes peripheral circuits for these components. The storage unit includes non-transitory tangible storage media. Based on programs stored in the storage unit, the ECU 2 performs various types of control processing and arithmetic processing to control the operation of devices connected to output ports of the ECU 2. Specifically, the ECU 2 of the first embodiment includes the signal processing device 3 as part of its electronic circuitry. The signal processing device 3 processes sensor signals transmitted from the sensor 6 and the like, and generates a control signal. The control circuit 24 of the ECU 2 controls the driving of the brake mechanism 5 based on the control signal generated by the signal processing device 3.

As the brake mechanism 5, various mechanisms can be adopted. For example, the brake mechanism 5 may be an electric brake that applies brakes to each wheel by driving an electric motor in response to a command from the ECU 2 to press brake pads against a disc brake rotor. Alternatively, for example, the brake mechanism 5 may be configured to increase the hydraulic pressure of the brake fluid by operating a master cylinder or a hydraulic pump, thereby driving wheel cylinders arranged on each wheel and operating the brake pads. In addition, the brake mechanism 5 is also capable of performing normal control, ABS control, VSC control, etc. in response to commands from the ECU 2. ABS stands for Anti-lock Braking System, and VSC stands for Vehicle Stability Control.

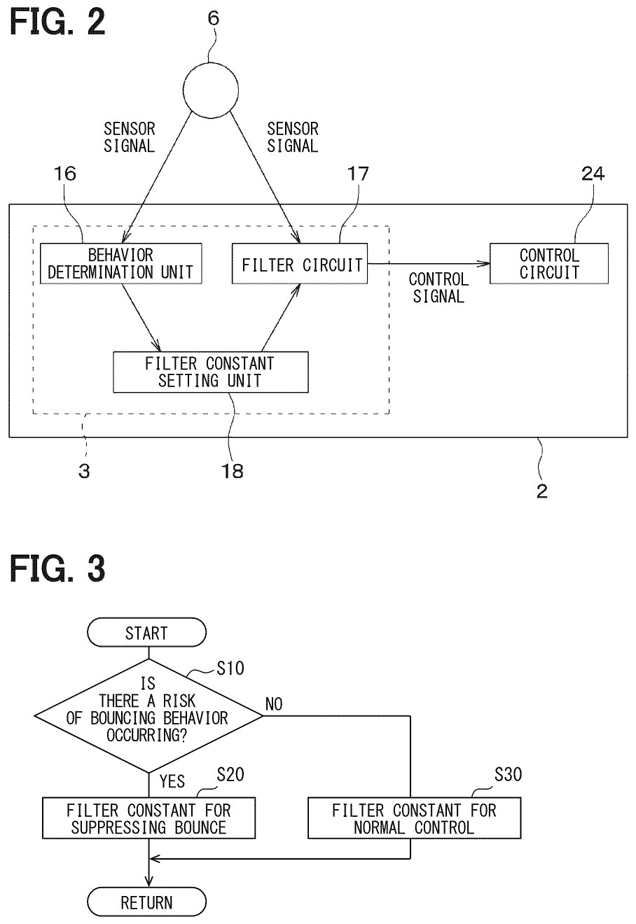

Next, the configuration of the signal processing device 3 that processes the sensor signal output from the sensor 6 of the brake pedal device 4 will be described with reference to FIG. 2.

As shown in FIG. 2, the signal processing device 3 includes a behavior determination unit 16, a filter circuit 17, and a filter constant setting unit 18 as functional blocks formed of electronic circuits.

The sensor signal output from the sensor 6 is input to the behavior determination unit 16 and the filter circuit 17.

The behavior determination unit 16 is a circuit that determines, based on the sensor signal, whether or not a bouncing behavior occurs after the pedal arm 8 rotates in the closing direction and reaches the fully closed position. The behavior determination unit 16 is configured to be able to determine whether or not a bouncing behavior will occur before the bouncing behavior occurs. The specific method by which the behavior determination unit 16 determines whether or not the bouncing behavior will occur will be described in detail in the third to seventh embodiments described later.

The filter circuit 17 is a circuit that performs smoothing processing on the sensor signal in accordance with a filter constant, and generates a control signal for braking the vehicle. The filter circuit 17 generates a control signal that smooths the change in the sensor signal to a greater extent as the filter constant increases. The filter circuit 17 may be implemented using various techniques, such as a moving average processing filter or a low-pass filter. For example, when the moving average processing filter is used as the filter circuit 17, the filter constant is the moving average time. For example, when the low-pass filter is used as the filter circuit 17, the filter constant is a time constant.

The filter constant setting unit 18 is a circuit that sets a filter constant used in the filter circuit 17 based on the result of the determination by the behavior determination unit 16. The filter constant setting unit 18 sets the filter constant when the behavior determination unit 16 determines that the bouncing behavior will occur to be larger than the filter constant when the behavior determination unit 16 determines that the bouncing behavior will not occur. Specifically, when the behavior determination unit 16 determines that a bouncing behavior will occur, the filter constant setting unit 18 sets the filter constant to a “filter constant for bouncing suppression.” On the other hand, when the behavior determination unit 16 determines that the bouncing behavior will not occur, the filter constant setting unit 18 sets the filter constant to the “filter constant for normal control.” The “filter constant for bouncing suppression” is a value larger than the “filter constant for normal control” and causes the filter circuit 17 to generate a control signal that smooths the change in the sensor signal to a greater degree.

Next, the control process executed by the signal processing device 3 will be described with reference to the flowchart of FIG. 3. In the following explanation and drawings, a step is simply represented as “S”.

In S10 of FIG. 3, the behavior determination unit 16 determines, based on the sensor signal input from the sensor 6, whether or not there is a risk of the bouncing behavior occurring. That is, the behavior determination unit 16 determines whether or not a bouncing behavior will occur after the pedal arm 8 rotates in the closing direction and reaches the fully closed position, before the bouncing behavior occurs.

When the behavior determination unit 16 determines in S10 that there is a risk of a bouncing behavior occurring, the process proceeds to S20. In S20, the filter constant setting unit 18 sets the filter constant to a “filter constant for suppressing bounce.” As a result, the filter circuit 17 generates a control signal in which the change in the sensor signal is smoothed to a greater degree. The control circuit 24 of the ECU 2 controls the driving of the brake mechanism 5 based on the control signal. Therefore, even if the driver removes his/her foot from the pedal arm 8 and a bouncing behavior occurs after the pedal arm 8 reaches the fully closed position, the control circuit 24 of the ECU 2 can immediately release the vehicle braking command to the brake mechanism 5.

On the other hand, when the behavior determination unit 16 determines in S10 that there is no risk of the bouncing behavior occurring, the process proceeds to S30. In S30, the filter constant setting unit 18 sets the filter constant to the “filter constant for normal control”. As a result, the filter circuit 17 generates a control signal in which the degree of smoothing of the change in the sensor signal is relatively small. The control circuit 24 of the ECU 2 controls the driving of the brake mechanism 5 based on the control signal. Therefore, when the driver depresses and releases the pedal arm 8 with his/her foot on the pedal arm 8, the control circuit 24 of the ECU 2 can perform vehicle braking with high responsiveness.

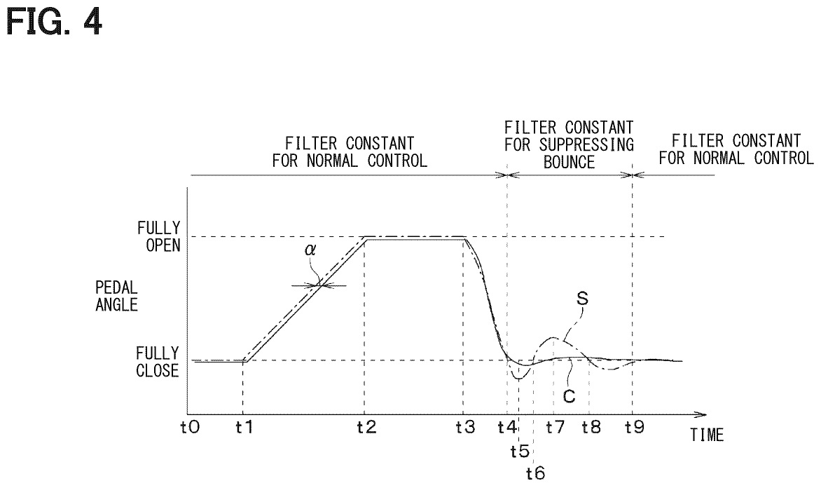

Next, the control process executed by the signal processing device 3 will be described with reference to the graph of FIG. 4, in terms of the relationship between the sensor signal and the control signal.

A horizontal axis of FIG. 4 indicates time, and a vertical axis indicates the angle of the pedal arm 8, that is, the pedal angle. On the vertical axis, “fully closed” is the angle when the pedal arm 8 is in the fully closed position, and indicates a state in which the driver is not applying the brakes. On the other hand, on the vertical axis, “fully open” is the angle when the pedal arm 8 is in the fully open position, and indicates a state in which the driver is applying full brakes. In FIG. 4, the dashed dotted line S indicates the sensor signal, and the solid line C indicates the control signal.

The sensor signal indicated by the dashed dotted line Sin FIG. 4 is a raw sensor value, and indicates the actual angle of the pedal arm 8. Therefore, as indicated by the dashed dotted line S, at time t1, the driver starts to depress the pedal arm 8, and the pedal arm 8 starts to rotate in the opening direction from the fully closed position. At time t2, the pedal arm 8 reaches the fully open position. At time t3, the driver releases his/her foot from the pedal arm 8, and the pedal arm 8 starts to rotate in the closing direction from the fully open position only by the biasing force of the spring mechanism 10. At time t4, the pedal arm 8 reaches the fully closed position and collides with the full-close stopper 9. From time t4 to t5, the full-close stopper 9 contracts due to the impact force of the pedal arm 8, and then from time t5 to t6, the full-close stopper 9 returns to its original shape due to its own elastic force. Therefore, during the period from time t6 to time t9, the pedal arm 8 exhibits a bouncing behavior.

A solid line C in FIG. 4 indicates a control signal generated by the filter circuit 17. From time t0 to t4, the behavior determination unit 16 determines that there is no risk of bouncing behavior occurring, and the filter constant setting unit 18 sets the filter constant to the “filter constant for normal control.” As a result, the filter circuit 17 generates a control signal in which the degree of smoothing of the change in the sensor signal is relatively small. Therefore, during the period from time t1 to time t2 when the driver depresses the pedal arm 8, a delay time Δα between the sensor signal and the control signal is small. Therefore, when the pedal arm 8 is depressed, the control circuit 24 of the ECU 2 can perform vehicle braking with high responsiveness.

When the behavior determination unit 16 determines that there is a risk of bouncing behavior occurring between times t3 and t4, the filter constant setting unit 18 sets the filter constant to a “filter constant for bouncing suppression” for a certain period of time from time t4 (for example, between times t4 and t9). As a result, the filter circuit 17 generates a control signal in which the change in the sensor signal is smoothed to a greater degree. Therefore, even if the pedal arm 8 is bouncing between times t4 and t9, the control circuit 24 of the ECU 2 can immediately release the vehicle braking command to the brake mechanism 5 based on the control signal.

At time t9, a certain time has elapsed since time t4, the filter constant setting unit 18 sets the filter constant to the “filter constant for normal control.” As a result, when the driver starts depressing the pedal arm 8 again after time t9, the control circuit 24 of the ECU 2 can perform vehicle braking with high responsiveness.

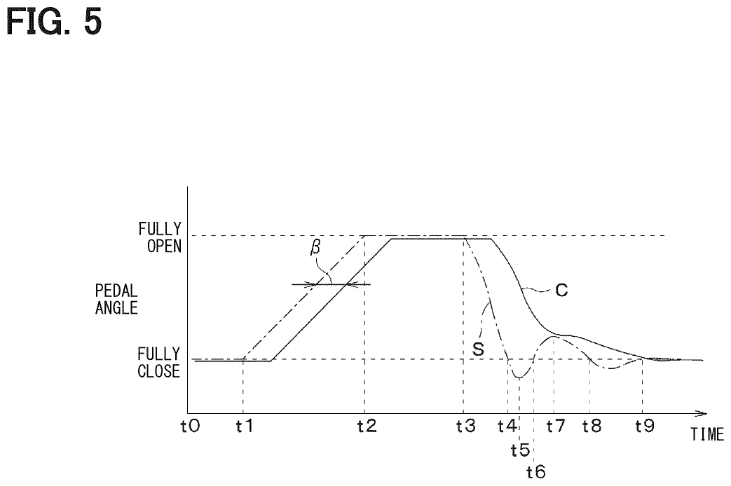

For comparison with the control process of the first embodiment described above, a relationship between the sensor signal and the control signal in a signal processing device of a comparative example will be described with reference to the graph of FIG. 5.

Although not shown in the figure, the signal processing device of the comparative example only includes a filter circuit, and does not include the behavior determination unit 16 and the filter constant setting unit 18. The filter constant of the filter circuit of the comparative example is always set to a value approximately equal to the “filter constant for suppressing bounce”described in the first embodiment.

The sensor signal indicated by the dashed dotted line Sin FIG. 5, i.e., the actual angle of the pedal arm 8, is the same as that described in the first embodiment.

The control signal indicated by the solid line C in FIG. 5 is generated by the filter circuit of the comparative example described above. During the period from time t1 to time t2 when the driver depresses the pedal arm 8, the delay time Δβ between the sensor signal and the control signal is greater than the delay time Δα described in the first embodiment. Therefore, in the comparative example, when the pedal arm 8 is depressed, there is a problem that the drivability deteriorates due to a delay in the response of the vehicle braking.

In contrast to the comparative example described above, the signal processing device 3 of the first embodiment provides the following advantageous effects.

The signal processing device 3 of the first embodiment includes the behavior determination unit 16, the filter circuit 17, and the filter constant setting unit 18. The behavior determination unit 16 determines whether or not a bouncing behavior occurs in the pedal arm 8 based on the sensor signal. The filter circuit 17 performs smoothing processing on the sensor signal in accordance with a filter constant, and generates a control signal. The filter constant setting unit 18 sets the filter constant when the behavior determination unit 16 determines that the bouncing behavior will occur to be larger than the filter constant when the behavior determination unit 16 determines that the bouncing behavior will not occur.

According to this configuration, when the behavior determination unit 16 determines that a bouncing behavior will occur, the filter constant setting unit 18 sets the filter constant to a large value, and the filter circuit 17 generates a control signal that greatly smooths the change in the sensor signal. Therefore, even if the driver removes his/her foot from the pedal arm 8 from the state in which the pedal arm 8 is depressed and the pedal arm 8 bounces back, the control circuit 24 of the ECU 2 immediately releases the vehicle braking command to the brake mechanism 5 based on the control signal in which the change in the sensor signal has been largely smoothed. Therefore, the drivability can be improved.

On the other hand, when the driver presses and releases the pedal arm 8 in a state in which the driver places his/her foot on the pedal arm 8, the pedal arm 8 does not rotate in the closing direction and collide with the full-close stopper 9 solely due to the biasing force of the spring mechanism 10, and the behavior determination unit 16 determines that no bouncing behavior will occur. Therefore, the filter constant setting unit 18 sets the filter constant to a value smaller than that when the bouncing behavior occurs, and the filter circuit 17 generates a control signal that smooths the change in the sensor signal to a smaller degree. Therefore, when the driver depresses and releases the pedal arm 8 with his/her foot on the pedal arm 8, the control circuit 24 of the ECU 2 performs vehicle braking with high response based on a control signal with a small degree of smoothing of the change in the sensor signal, thereby improving drivability.

Furthermore, according to the signal processing performed by the signal processing device 3, even if the pedal arm 8 exhibits a bouncing behavior, the control circuit 24 of the ECU 2 immediately cancels the vehicle braking command to the brake mechanism 5. Therefore, there is no unnecessary increase in the number of operations for vehicle braking, and unnecessary wear on the brake pads, etc. can be prevented.

Furthermore, according to the signal processing of the signal processing device 3, even if the biasing force of the spring mechanism 10 provided in the brake pedal device 4 is increased, there is no need to increase the size of the full-close stopper 9 that physically absorbs the collision force of the pedal arm 8, and drivability can be improved through control. Therefore, an increase in size of the brake pedal device 4 due to an increase in the size of the full-close stopper 9 can be prevented, and manufacturing costs can be reduced.

In the signal processing device 3 of the first embodiment, the behavior determination unit 16 may determine the magnitude of the bouncing behavior based on a sensor signal. In this case, the filter constant setting unit 18 may set the “filter constant for bouncing suppression” to a larger value as the bouncing behavior increases. Furthermore, the filter constant setting unit 18 may set the time for applying the “filter constant for bouncing suppression” to the filter circuit 17 to be longer as the bounce behavior increases. In detail, the filter constant setting unit 18 may set a longer time from when the “filter constant for bouncing suppression” is set until when the “filter constant for normal control”is returned, as the bouncing behavior becomes larger.

### Second Embodiment

A second embodiment will be described. In the second embodiment, the configuration of the signal processing device 3 and the control method thereof are changed from those in the first embodiment, but other aspects are similar to those in the first embodiment, so only the portions that differ from the first embodiment will be described.

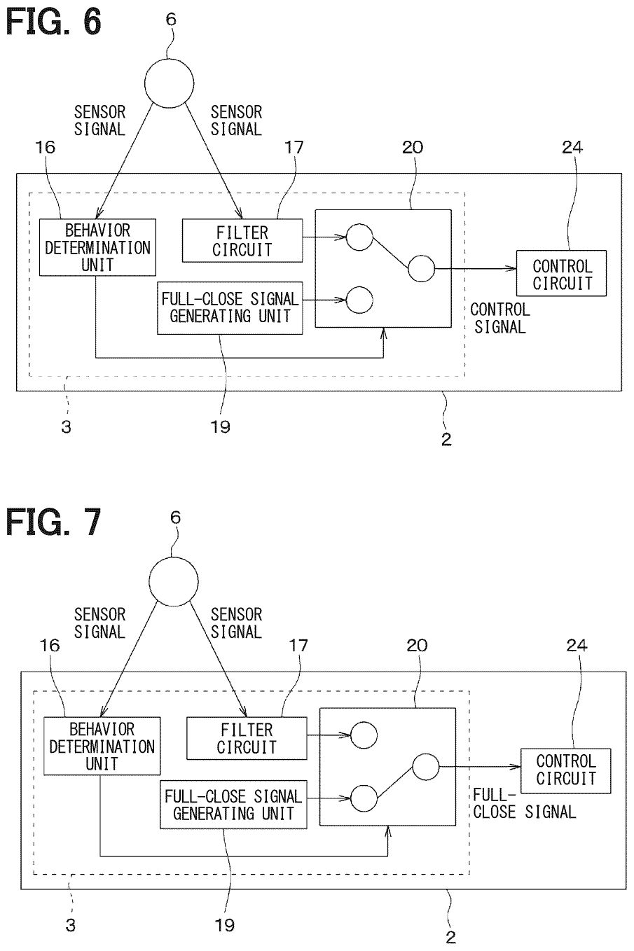

As shown in FIG. 6, the signal processing device 3 of the second embodiment includes the behavior determination unit 16, the filter circuit 17, a full-close signal generating unit 19, and a signal switching unit 20 as functional blocks formed of electronic circuits.

The sensor signal output from the sensor 6 is input to the behavior determination unit 16 and the filter circuit 17.

The behavior determination unit 16 is a circuit that determines, based on the sensor signal, whether or not a bouncing behavior occurs after the pedal arm 8 rotates in the closing direction and reaches the fully closed position. The behavior determination unit 16 is configured to be able to determine whether or not a bouncing behavior will occur before the bouncing behavior occurs. The specific method by which the behavior determination unit 16 determines whether or not the bouncing behavior will occur will be described in detail in the third to seventh embodiments described later.

The filter circuit 17 is a circuit that performs smoothing processing on the sensor signal in accordance with a filter constant, and generates a control signal for braking the vehicle. The filter circuit 17 may be implemented using various techniques, such as a moving average processing filter or a low-pass filter. In the second embodiment, the filter circuit 17 is not essential, and the signal processing device 3 may be configured without the filter circuit 17.

The full-close signal generating unit 19 is a circuit that generates and outputs a full-close signal. In this specification, the full-close signal refers to a signal value indicating that the pedal arm 8 is in the fully closed position.

The signal switching unit 20 is a circuit that switches between the control signal generated by the filter circuit 17 and the full-close signal generated by the full-close signal generating unit 19 and outputs the switched signal based on the determination result by the behavior determination unit 16. When the behavior determination unit 16 determines that the bouncing behavior will not occur, the signal switching unit 20 outputs a control signal generated by the filter circuit 17, as shown in FIG. 6. On the other hand, when the behavior determination unit 16 determines that the bouncing behavior will occur, as shown in FIG. 7, the signal switching unit 20 switches the control signal to the full-close signal generated by the full-close signal generating unit 19 and outputs it for a predetermined time.

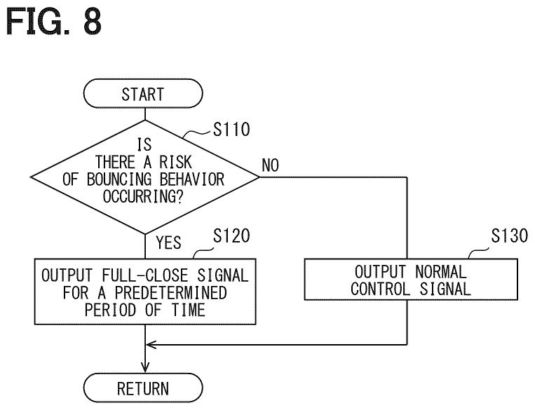

Next, the control process executed by the signal processing device 3 of the second embodiment will be described with reference to the flowchart of FIG. 8.

In S110 of FIG. 8, the behavior determination unit 16 determines, based on the sensor signal input from the sensor 6, whether or not there is a risk of the bouncing behavior occurring. That is, the behavior determination unit 16 determines whether or not a bouncing behavior will occur after the pedal arm 8 rotates in the closing direction and reaches the fully closed position, before the bouncing behavior occurs.

When the behavior determination unit 16 determines in S110 that there is a risk of a bouncing behavior occurring, the process proceeds to S120. In S120, the signal switching unit 20 switches the control signal to the full-close signal generated by the full-close signal generating unit 19 and outputs the full-close signal for a predetermined period of time. As a result, the control circuit 24 of the ECU 2 controls the driving of the brake mechanism 5 based on the full-close signal. Therefore, even if the driver removes his/her foot from the pedal arm 8 and a bouncing behavior occurs after the pedal arm 8 reaches the fully closed position, the control circuit 24 of the ECU 2 can immediately release the vehicle braking command to the brake mechanism 5.

On the other hand, when the behavior determination unit 16 determines in S110 that there is no risk of the bouncing behavior occurring, the process proceeds to S130. In S130, the signal switching unit 20 outputs the normal control signal generated by the filter circuit 17. When the signal processing device 3 does not include the filter circuit 17, the signal switching unit 20 outputs the sensor signal as a control signal. The control circuit 24 of the ECU 2 controls the driving of the brake mechanism 5 based on the control signal or the sensor signal. Therefore, when the driver depresses and releases the pedal arm 8 with his/her foot on the pedal arm 8, the control circuit 24 of the ECU 2 can perform vehicle braking with high responsiveness.

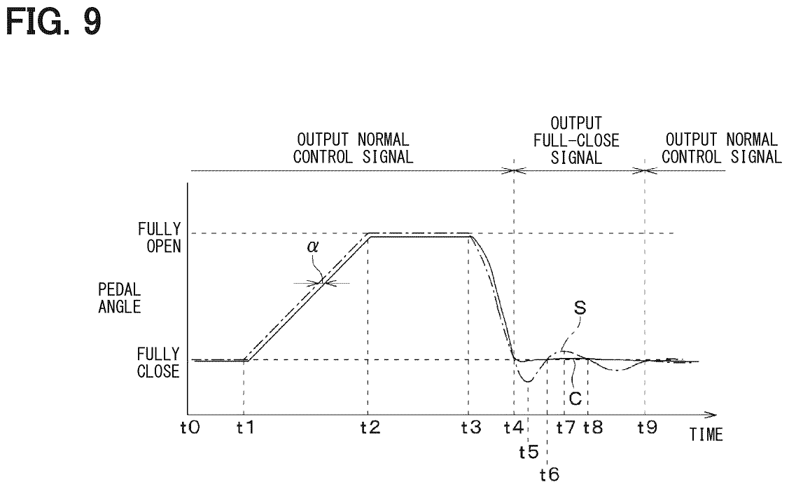

Next, the control process executed by the signal processing device 3 will be described with reference to a graph of FIG. 9 with respect to the relationship between the sensor signal, the control signal, and the full-close signal.

The sensor signal indicated by the dashed dotted line Sin FIG. 9, i.e., the actual angle of the pedal arm 8, is the same as that described in the first embodiment.

A solid line C in FIG. 9 indicates the control signal and the full-close signal output from the signal switching unit 20. From time t0 to t4, the behavior determination unit 16 determines that there is no risk of bouncing behavior occurring, and the signal switching unit 20 outputs a normal control signal generated by the filter circuit 17. Therefore, during the period from time t1 to time t2 when the driver depresses the pedal arm 8, a delay time Δα between the sensor signal and the control signal is very small. Therefore, when the pedal arm 8 is depressed, the control circuit 24 of the ECU 2 can perform vehicle braking with high responsiveness.

When the behavior determination unit 16 determines that there is a risk of bouncing behavior occurring between times t3 and t4, the signal switching unit 20 switches the control signal to the full-close signal generated by the full-close signal generating unit 19 and outputs it for a predetermined period of time from time t4 (for example, between times t4 and t9). Therefore, even if the pedal arm 8 is bouncing between times t4 and t9, the control circuit 24 of the ECU 2 can immediately release the vehicle braking command to the brake mechanism 5 based on the full-close signal.

At time t9, which is a certain time after time t4, the signal switching unit 20 switches to the normal control signal generated by the filter circuit 17 and outputs it. As a result, when the driver starts depressing the pedal arm 8 again after time t9, the control circuit 24 of the ECU 2 can perform vehicle braking with high responsiveness.

The signal processing device 3 of the second embodiment described above provides the following advantageous effects.

The signal processing device 3 of the second embodiment includes the behavior determination unit 16 and the signal switching unit 20. The behavior determination unit 16 determines whether or not a bouncing behavior occurs in the pedal arm 8 based on the sensor signal. When the behavior determination unit 16 determines that the bouncing behavior will occur, the signal switching unit 20 switches the control signal to a full-close signal for a predetermined period of time and outputs it.

According to this configuration, when the behavior determination unit 16 determines that a bouncing behavior will occur, the signal switching unit 20 switches the control signal to a full-close signal for a predetermined period of time and outputs it. Therefore, even if the driver removes his/her foot from the pedal arm 8 while depressing it, causing the pedal arm 8 to bounce back, the control circuit 24 of the ECU 2 immediately releases the vehicle braking command to the brake mechanism 5 based on the full-close signal, thereby improving drivability.

On the other hand, when the driver presses and releases the pedal arm 8 in a state in which the driver places his/her foot on the pedal arm 8, the pedal arm 8 does not rotate in the closing direction and collide with the full-close stopper 9 solely due to the biasing force of the spring mechanism 10, and the behavior determination unit 16 determines that no bouncing behavior will occur. Therefore, the signal switching unit 20 does not switch the control signal to a full-close signal. Therefore, when the driver presses and releases the pedal arm 8 with his/her foot on the pedal arm 8, the control circuit 24 of the ECU 2 performs vehicle braking with high response based on the control signal that is normally processed from the sensor signal or the sensor signal, thereby improving drivability.

Furthermore, according to the signal processing of the signal processing device 3, as in the first embodiment, there is no unnecessary increase in the number of operations for vehicle braking, and unnecessary wear of the brake pads and the like can be prevented.

Furthermore, according to the signal processing of the signal processing device 3, as in the first embodiment, there is no need to increase the size of the full-close stopper 9, so that the brake pedal device 4 can be prevented from becoming larger and manufacturing costs can be reduced.

In the signal processing device 3 of the second embodiment, the behavior determination unit 16 may determine the magnitude of the bouncing behavior based on a sensor signal. In this case, the signal switching unit 20 may output a full-close signal for a longer period of time as the bouncing behavior increases. In detail, the signal switching unit 20 may increase the time from switching the normal control signal generated by the filter circuit 17 to the full-close signal generated by the full-close signal generating unit 19 until switching back to the normal control signal generated by the filter circuit 17, the greater the bouncing behavior.

### Third to Seventh Embodiments

In contrast to the first and second embodiments, the third to seventh embodiments explain a specific method in which the behavior determination unit 16 determines whether or not a bouncing behavior will occur. In the description of the third to seventh embodiments, the signal processing device 3 will be described as including the behavior determination unit 16, the filter circuit 17, and the filter constant setting unit 18, similarly to the first embodiment. However, without being limited thereto, in the descriptions of the third to seventh embodiments, the signal processing device 3 may be equipped with the behavior determination unit 16, the filter circuit 17, the full-close signal generating unit 19 and the signal switching unit 20, as in the second embodiment.

### Third Embodiment:

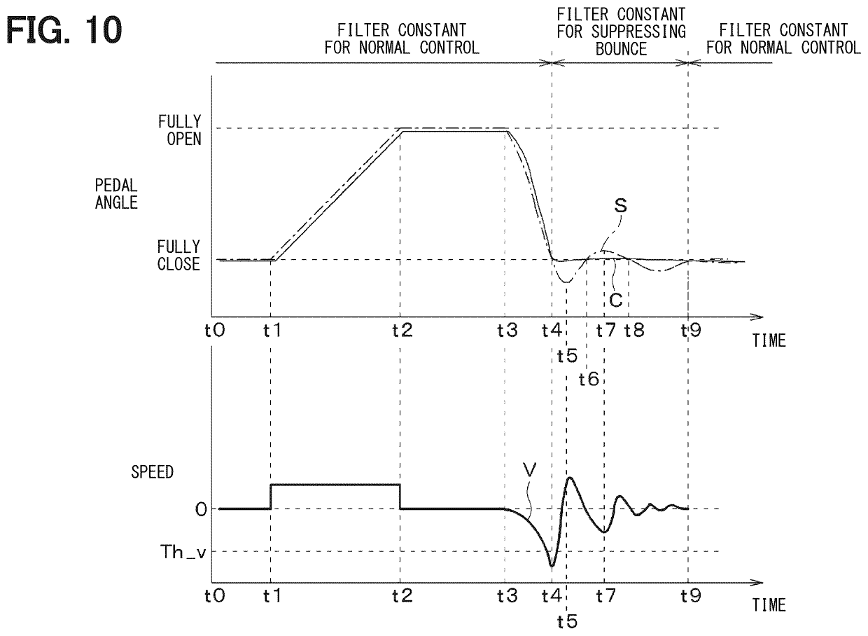

The relationship between the sensor signal and the control signal at the pedal angle shown in the upper part of the graph in FIG. 10 is substantially the same as that in the graph in FIG. 4 referred to in the description of the first embodiment, and therefore a description thereof will be omitted. In addition, the signal processing device 3 of the third embodiment is capable of outputting a control signal that is regarded as being fully closed when the sensor signal is smaller than a value indicating the fully closed state. Specifically, in the upper part of the graph in FIG. 10, between time t4 and t6 and between time t8 and t9, the signal processing device 3 can output a control signal that is regarded as being fully closed. This configuration also applies to the first and second embodiments described above, and to the fourth to seventh embodiments described below.

A line V in the lower part of the graph in FIG. 10 indicates the movement speed of the pedal arm 8. The behavior determination unit 16 included in the signal processing device 3 of the third embodiment is capable of calculating the movement speed of the pedal arm 8 from the differential value of the sensor signal. Then, the behavior determination unit 16 determines that a bouncing behavior will occur when the pedal arm 8 rotates in the closing direction at a speed equal to or greater than a predetermined speed threshold Th_v, or when the pedal arm 8 reaches the fully closed position at a speed equal to or greater than a predetermined speed threshold Th_v.

The predetermined speed threshold Th_v is set by experiment or the like depending on the depression force characteristic of the spring mechanism 10 included in the brake pedal device 4, and is stored in advance in the memory of the signal processing device 3. The memory is a non-transitory tangible storage medium. Further, a speed equal to or greater than the predetermined speed threshold Th_v means a speed that is equal to or greater than the predetermined speed threshold Th_v as an absolute value, regardless of the direction in which the pedal arm 8 moves.

In the third embodiment described above, the behavior determination unit 16 determines that a bouncing behavior will occur when the pedal arm 8 rotates in the closing direction at a speed equal to or greater than a predetermined speed threshold Th_v, or when the pedal arm 8 reaches the fully closed position at a speed equal to or greater than a predetermined speed threshold Th_v.

According to this configuration, when the driver releases his/her foot from the pedal arm 8, the pedal arm 8 rotates in the closing direction at a speed equal to or greater than a predetermined speed threshold Th_v due solely to the biasing force of the spring mechanism 10, and when it collides with the full-close stopper 9 in the fully closed position, a bouncing behavior occurs. Therefore, the behavior determination unit 16 can determine whether or not a bouncing behavior will occur before the bouncing behavior occurs by calculating the movement speed when the pedal arm 8 rotates in the closing direction from the differential value of the sensor signal.

In the signal processing device 3 of the third embodiment, the behavior determination unit 16 may determine the magnitude of the bouncing behavior based on a sensor signal. Specifically, the behavior determination unit 16 determines that the bouncing behavior is greater as the speed at which the pedal arm 8 rotates in the closing direction increases. In this case, the filter constant setting unit 18 described in the first embodiment may set the “filter constant for bouncing suppression” to a larger value as the bouncing behavior increases. Furthermore, the filter constant setting unit 18 may set the time for applying the “filter constant for bouncing suppression” to the filter circuit 17 to be longer as the bounce behavior increases. In this case, the signal switching unit 20 described in the second embodiment may output a full-close signal for a longer period of time as the bouncing behavior increases.

### Fourth Embodiment:

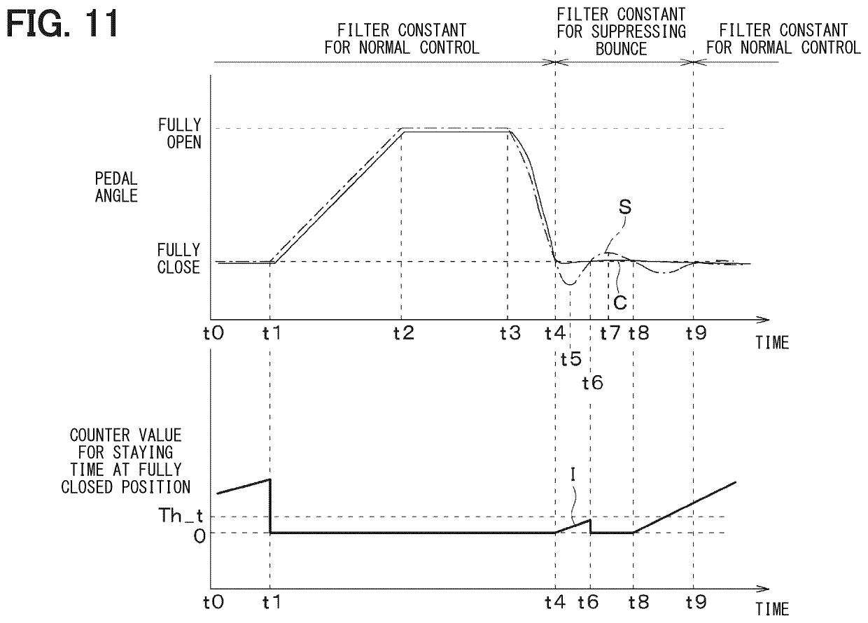

The relationship between the sensor signal and the control signal at the pedal angle shown in the upper part of the graph in FIG. 11 is substantially the same as that in the graph in FIG. 4 referred to in the description of the first embodiment, and therefore a description thereof will be omitted.

A line I in the lower part of the graph in FIG. 11 indicates a count value of the time that the pedal arm 8 stays at the fully closed position and in a position further in the closing direction than the fully closed position. The behavior determination unit 16 provided in the signal processing device 3 of the fourth embodiment has a counter circuit that counts the time when the pedal arm 8 is in the fully closed position and in the closing direction further than the fully closed position, and is capable of counting that time. Specifically, the vertical axis in the lower part of the graph in FIG. 11 represents the count value obtained by counting the time when the pedal arm 8 is in the fully closed position and in the closing direction further than the fully closed position. When the pedal arm 8 moves in the opening direction from the fully closed position, the count value is reset. In the line I of the graph in FIG. 11, the count value is reset at time t1, counting starts at time t4, and the count value is reset at time t6.

The behavior determination unit 16 determines that a bouncing behavior will occur when the time that the pedal arm 8 stays in the fully closed position and in a position further in the closing direction than the fully closed position, i.e., the counter value, is smaller than a predetermined time threshold Th_t. The time threshold Th_t is set to a time shorter than the time (e.g., 0.25 seconds) required for a person to vibrate the pedal arm 8 multiple times with his/her foot at the fastest speed, and is stored in advance in the memory of the signal processing device 3.

In the fourth embodiment described above, the behavior determination unit 16 determines that the bouncing behavior will occur when the time that the pedal arm 8 stays in the fully closed position or in a position further in the closing direction than the fully closed position is shorter than a predetermined time threshold Th_t.

According to this configuration, when the pedal arm 8 rotates in the closing direction only by the biasing force of the spring mechanism 10 and collides with the full-close stopper 9, the pedal arm 8 abuts against the full-close stopper 9 for only a short time that a person cannot operate it with his/her foot at the fastest speed, and then exhibits a bouncing behavior. Therefore, the behavior determination unit 16 can determine whether or not the bouncing behavior will occur before the bouncing behavior occurs by detecting the time that the pedal arm 8 stays in the fully closed position and in a position further in the closing direction than the fully closed position.

In the signal processing device 3 of the fourth embodiment, the behavior determination unit 16 may determine the magnitude of the bouncing behavior based on a sensor signal. Specifically, the behavior determination unit 16 determines that the bouncing behavior is greater as the time that the pedal arm 8 stays in the fully closed position and in a position further in the closing direction than the fully closed position is shorter. In this case, the filter constant setting unit 18 described in the first embodiment may set the “filter constant for bouncing suppression” to a larger value as the bouncing behavior increases. Furthermore, the filter constant setting unit 18 may set the time for applying the “filter constant for bouncing suppression” to the filter circuit 17 to be longer as the bounce behavior increases. In this case, the signal switching unit 20 described in the second embodiment may output a full-close signal for a longer period of time as the bouncing behavior increases.

### Fifth Embodiment:

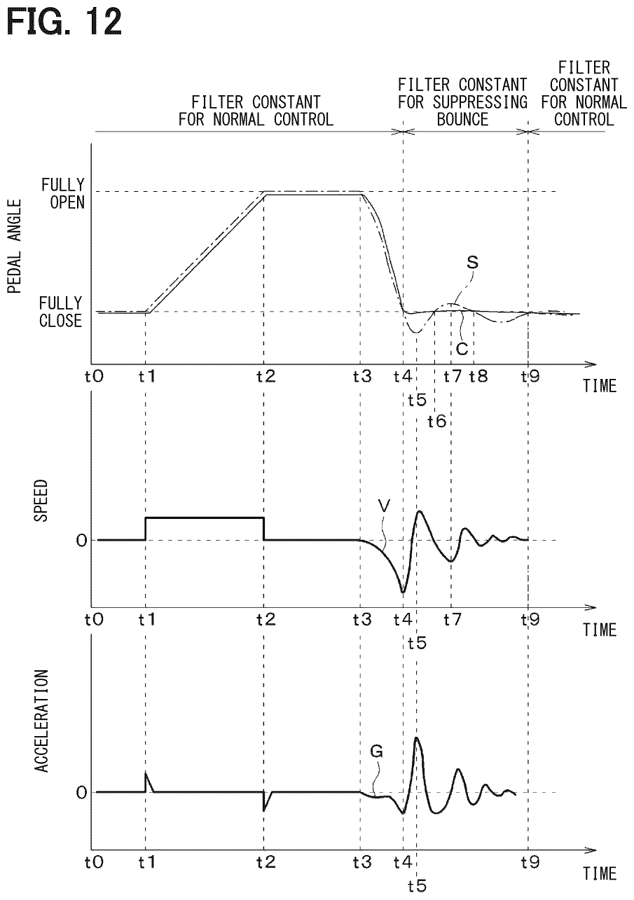

The relationship between the sensor signal and the control signal at the pedal angle shown in the upper part of the graph in FIG. 12 is substantially the same as that in the graph in FIG. 4 referred to in the description of the first embodiment, and therefore a description thereof will be omitted. A line V in the middle part of the graph in FIG. 12 represents the movement speed of the pedal arm 8, and since this line is substantially the same as the line V in the lower part of the graph in FIG. 10 referred to in the explanation of the third embodiment, a description thereof will be omitted.

A line G in the lower part of the graph in FIG. 12 indicates an acceleration of the movement of the pedal arm 8. The behavior determination unit 16 included in the signal processing device 3 of the fifth embodiment is capable of calculating the acceleration of the movement of the pedal arm 8 from the second-order differential value of the sensor signal. Then, the behavior determination unit 16 determines that a bouncing behavior will occur when the pedal arm 8 rotates in the closing direction at an acceleration equal to or greater than a predetermined acceleration threshold Th_a, or when the pedal arm 8 reaches the fully closed position at an acceleration equal to or greater than a predetermined acceleration threshold Th_a. The acceleration equal to or greater than the predetermined acceleration threshold Th_a means an acceleration whose absolute value is equal to or greater than the predetermined acceleration threshold Th_a, regardless of the direction in which the pedal arm 8 moves. Furthermore, the predetermined acceleration threshold Th_a is a constant value or a value that is uniquely determined according to the angle or stroke amount of the pedal arm 8 based on the characteristic of the spring mechanism 10 and the mass of the pedal arm 8.

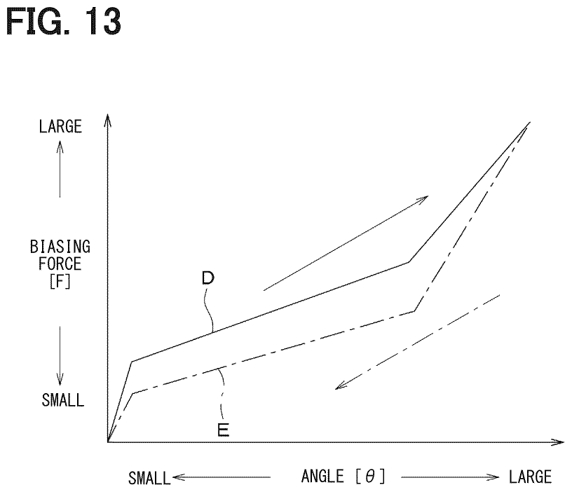

FIG. 13 is a graph showing the relationship between the angle θ or stroke amount of the pedal arm 8 and the biasing force F(θ) acting on the pedal arm 8 from the spring mechanism 10. This graph is set when the spring mechanism 10 is designed, and is called the pedal force characteristic of the spring mechanism 10. A solid line D in the graph of FIG. 13 shows the relationship between the angle θ or stroke amount of the pedal arm 8 and the biasing force F(θ) acting on the pedal arm 8 from the spring mechanism 10 when the pedal arm 8 rotates in the opening direction. Further, a dashed dotted line E indicates the relationship between the angle θ or stroke amount of the pedal arm 8 and the biasing force F(θ) acting on the pedal arm 8 from the spring mechanism 10 when the pedal arm 8 rotates in the closing direction.

Here, when the pedal arm 8 rotates in the closing direction, the biasing force F(θ) acting on the pedal arm 8 from the spring mechanism 10 at a predetermined angle θ, the acceleration a at that predetermined angle θ, and the mass m of the pedal arm 8 have the following relationship expressed by Equation 1 from the equation of motion.

$$F ( θ ) = ma \qquad Equation ( 1 )$$

From the above Equation 1, when the pedal arm 8 rotates in the closing direction, the acceleration a at a predetermined angle θ has the relationship of the following Equation 2.

$$a = F ( θ ) / m \qquad Equation ( 2 )$$

As described above, the biasing force F(θ) acting on the pedal arm 8 from the spring mechanism 10 at a predetermined angle θ has a value that is set at the time of design as the pedal force characteristic of the spring mechanism 10.

Therefore, when the pedal arm 8 rotates in the closing direction, in a case where the acceleration a at a predetermined angle θ is smaller than the value obtained by dividing the biasing force F(θ) set at the predetermined angle θ at the time of design by the mass m of the pedal arm 8, it is considered that the driver's foot is placed on the pedal arm 8. In this case, no bouncing motion occurs after the pedal arm 8 hits the full-close stopper 9.

On the other hand, when the pedal arm 8 rotates in the closing direction, in a case where the acceleration a at a predetermined angle θ is equivalent to the value obtained by dividing the spring force F(θ) set at that predetermined angle θ at the time of design by the mass m of the pedal arm 8, it can be considered as follows. In other words, in this case, the driver's foot is not placed on the pedal arm 8, and the pedal arm 8 rotates in the closing direction only by the biasing force of the spring mechanism 10, so it is thought that a bouncing behavior occurs after the pedal arm 8 collides with the full-close stopper 9. Incidentally, “the acceleration a at a predetermined angle θ is equivalent to the value obtained by dividing the biasing force F(θ) set at the predetermined angle θ at the time of design by the mass m of the pedal arm 8” is intended to include the fact that the acceleration a will be slightly reduced due to friction of the shaft 12, etc., air resistance to the pedal arm 8, etc. Therefore, by setting the specified acceleration threshold Th_a to a value that is uniquely determined according to the angle or stroke amount of the pedal arm 8 based on the characteristic of the spring mechanism 10 and the mass m of the pedal arm 8, it is possible to accurately determine whether or not bouncing behavior will occur. The predetermined acceleration threshold Th_a may be determined experimentally, and is a value that is uniquely determined, including an error, as to what level of acceleration is required to cause a bouncing behavior.

In addition, when the pedal arm 8 rotates at an acceleration greater than a certain constant value, the bouncing behavior occurs after the pedal arm 8 collides with the full-close stopper 9, so it is also possible to set the specified acceleration threshold Th_a to a certain constant value.

In the fifth embodiment described above, the behavior determination unit 16 determines that the bouncing behavior will occur when an acceleration equal to or greater than a predetermined acceleration threshold Th_a occurs while the pedal arm 8 is rotating in the closing direction and reaching the fully closed position.

According to this configuration, when the driver releases his/her foot from the pedal arm 8, the pedal arm 8 rotates in the closing direction at an acceleration equal to or greater than a predetermined acceleration due only to the biasing force of the spring mechanism 10, and when it collides with the full-close stopper 9 at the full-close position, the bouncing behavior occurs. Therefore, the behavior determination unit 16 can determine whether or not a bouncing behavior will occur before the bouncing behavior occurs by calculating the acceleration of the pedal arm 8 from the second-order differential value of the sensor signal.

In addition, in the fifth embodiment, the predetermined acceleration threshold Th_a used by the behavior determination unit 16 to determine the bouncing behavior is a constant value or a value that is uniquely determined depending on the angle or stroke amount of the pedal arm 8 based on the characteristic of the spring mechanism 10 and the mass m of the pedal arm 8. According to this configuration, the behavior determination unit 16 can accurately determine whether or not a bouncing behavior will occur.

In the signal processing device 3 of the fifth embodiment, the behavior determination unit 16 may determine the magnitude of the bouncing behavior based on a sensor signal. Specifically, the behavior determination unit 16 determines that the bouncing behavior is greater as the acceleration of the pedal arm 8 when it rotates in the fully-closing direction is greater. In this case, the filter constant setting unit 18 described in the first embodiment may set the “filter constant for bouncing suppression” to a larger value as the bouncing behavior increases. Furthermore, the filter constant setting unit 18 may set the time for applying the “filter constant for bouncing suppression” to the filter circuit 17 to be longer as the bounce behavior increases. In this case, the signal switching unit 20 described in the second embodiment may output a full-close signal for a longer period of time as the bouncing behavior increases.

### Sixth Embodiment:

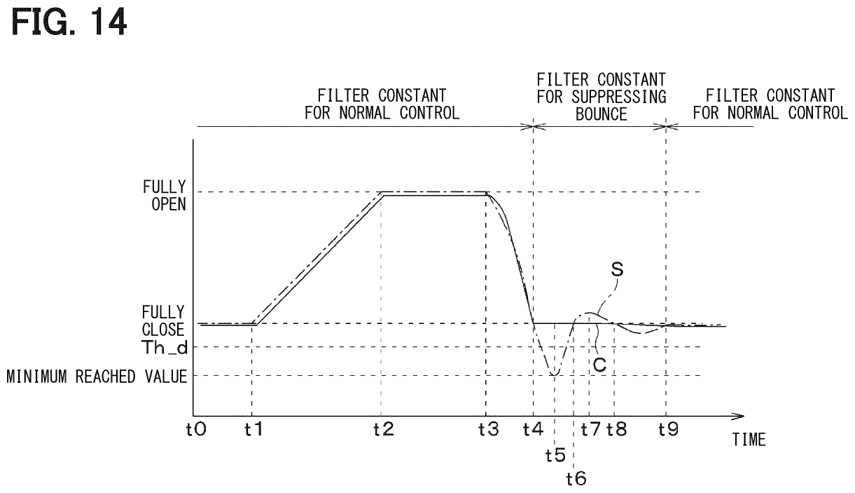

The relationship between the sensor signal and the control signal at the pedal angle shown in the graph in FIG. 14 is substantially the same as that in the graph in FIG. 4 referred to in the description of the first embodiment, and therefore a description thereof will be omitted. In the graph of FIG. 14, for ease of explanation, the distance that the pedal arm 8 moves in the full-closing direction from the fully closed position between time t4 and time t5 is exaggerated.

The behavior determination unit 16 determines that a bouncing behavior will occur when the pedal arm 8 moves by a distance of Th_d or more in the closing direction from the fully closed position. The reason is that when the impact force between the pedal arm 8 and the full-close stopper 9 is large, the full-close stopper 9 is largely deflected, and then the bouncing behavior occurs. Therefore, the behavior determination unit 16 determines whether the pedal arm 8 has significantly deflected the full-close stopper 9 due to the collision force, i.e., whether the pedal arm 8 has moved further by a distance of Th_d or more in the closing direction from the fully closed position. This allows the behavior determination unit 16 to determine whether or not the bouncing behavior will occur before the bouncing behavior occurs.

In the signal processing device 3 of the sixth embodiment, the behavior determination unit 16 may determine the magnitude of the bouncing behavior based on a sensor signal. Specifically, the behavior determination unit 16 determines that the bouncing behavior is greater as the distance that the pedal arm 8 has moved in the closing direction from the fully closed position increases. In this case, the filter constant setting unit 18 described in the first embodiment may set the “filter constant for bouncing suppression” to a larger value as the bouncing behavior increases. Furthermore, the filter constant setting unit 18 may set the time for applying the “filter constant for bouncing suppression” to the filter circuit 17 to be longer as the bounce behavior increases. In this case, the signal switching unit 20 described in the second embodiment may output a full-close signal for a longer period of time as the bouncing behavior increases.

### Seventh Embodiment:

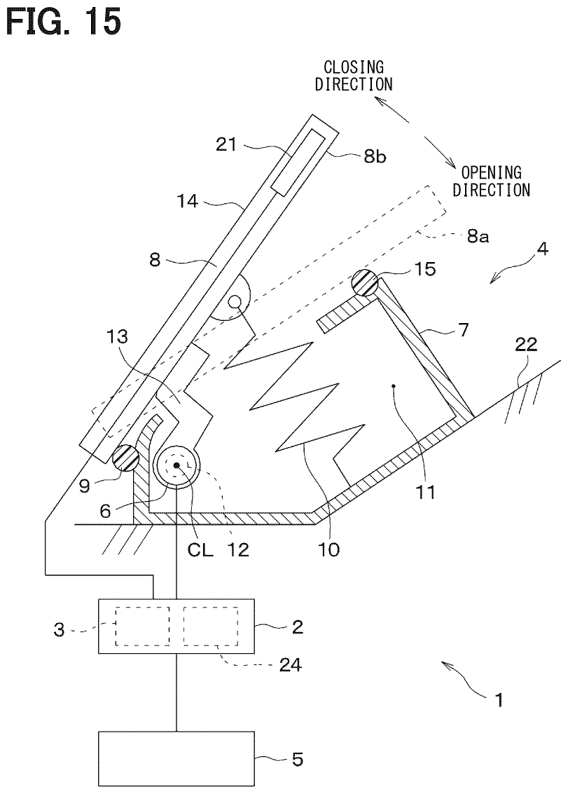

As shown in FIG. 15, the brake pedal device 4 to which the signal processing device 3 of the seventh embodiment is applied is provided with a load sensor 21 that detects whether or not the driver's pedal force is being applied to the pedal arm 8. The signal output from the load sensor 21 is transmitted to the signal processing device 3.

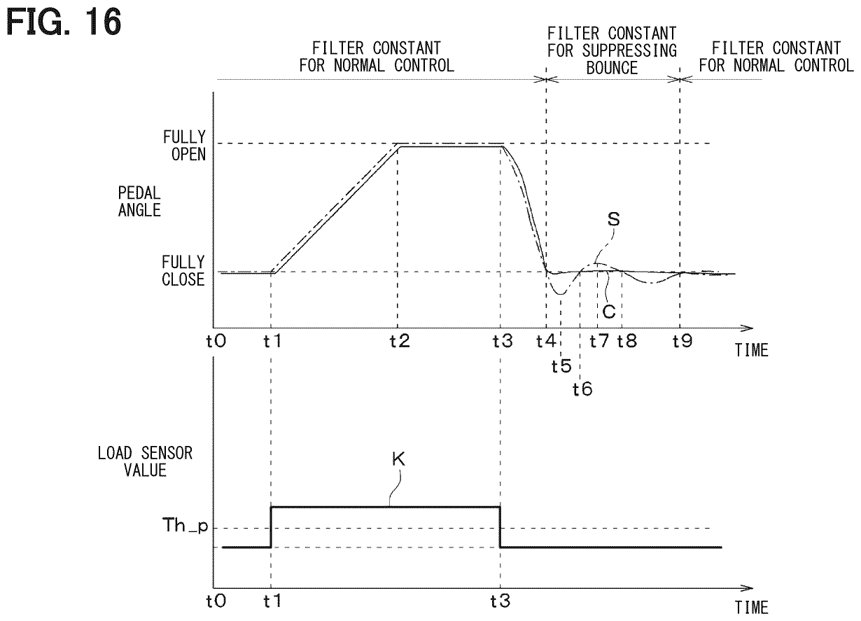

The relationship between the sensor signal and the control signal at the pedal angle shown in the upper part of the graph in FIG. 16 is substantially the same as that in the graph in FIG. 4 referred to in the description of the first embodiment, and therefore a description thereof will be omitted.

A line K in the lower part of the graph in FIG. 16 indicates the signal output from the load sensor 21, that is, the load sensor value. When the load sensor value is equal to or less than a predetermined load threshold Th_p, this shows a state in which no pedal force is being applied by the driver to the pedal arm 8, that is, a state in which the driver's foot is off the pedal arm 8. In the line K of the graph in FIG. 16, the pedal force of the driver is applied to the pedal arm 8 from time t1, and the pedal force of the driver is not applied to the pedal arm 8 from time t3 onwards. That is, the driver starts depressing the pedal arm 8 at time t1, depresses the pedal arm 8 to the fully open position at time t2, and then removes his/her foot from the pedal arm 8 at time t3. Therefore, as shown by the dotted line Sin the upper part of the graph in FIG. 16, after time t3, the pedal arm 8 rotates in the closing direction only by the biasing force of the spring mechanism 10, and after colliding with the full-close stopper 9 at time t4, the bouncing behavior occurs.

Based on the output signal of the load sensor 21 and the sensor signal, the behavior determination unit 16 determines that the bouncing behavior will occur when the pedal arm 8 rotates in the closing direction and reaches the fully closed position without the driver's pedal force being applied to the pedal arm 8. The reason is that when the driver releases his/her foot from the pedal arm 8, the pedal arm 8 rotates in the closing direction only by the biasing force of the spring mechanism 10 and collides with the full-close stopper 9 in the fully closed position, resulting in the bouncing behavior. Therefore, when the pedal arm 8 rotates in the closing direction and reaches the fully closed position, the behavior determination unit 16 can determine whether or not bouncing behavior will occur before the bouncing behavior occurs, depending on whether or not the driver's pedal force is applied to the pedal arm 8.

### Eighth Embodiment:

The eighth embodiment is different from the first to seventh embodiments in that the configuration of the brake pedal device 4 is changed, but otherwise is similar to the first to seventh embodiments, so only the parts that differ from the first to seventh embodiments will be described.

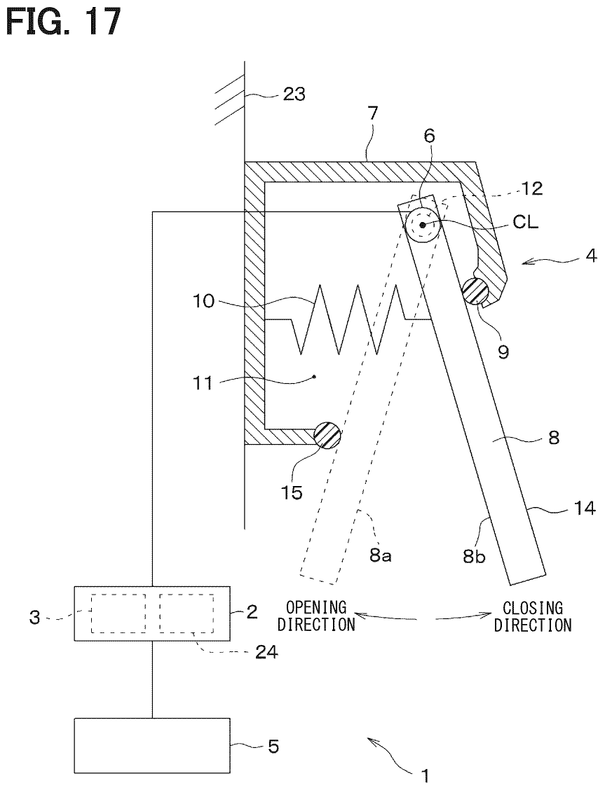

As shown in FIG. 17, a brake pedal device 4 to which a signal processing device 3 of the eighth embodiment is applied is a pendant type pedal device. The pendant type pedal device is a device in which all or most of the pedal tread surface 14, which is the part of the pedal arm 8 to which the driver's pedal force is applied, is positioned downward in the vertical direction (i.e., below the vehicle) with respect to the rotation axis CL of the pedal arm 8 when mounted on the vehicle.

The housing 7 serving as a support is fixed to a dash panel 23 or the like by bolts or the like (not shown). The pedal arm 8 is supported rotatably relative to the housing 7. A dashed line 8a in FIG. 17 indicates a state in which the pedal arm 8 and the full-open stopper 15 abut against each other and the pedal arm 8 is in the fully open position. A solid line 8b in FIG. 17 indicates a state in which the pedal arm 8 and the full-close stopper 9 abut against each other and the pedal arm 8 is in the fully closed position.

The sensor 6 detects the pedal arm 8 or the shaft 12 and outputs a sensor signal according to the angle or stroke amount of the pedal arm 8 as the pedal arm 8 or the shaft 12 is the detection target. The sensor signal output from the sensor 6 is transmitted to the ECU. The ECU 2 incorporates the signal processing device 3 described in the first to seventh embodiments. In the configuration of the eighth embodiment, the signal processing device 3 is not limited to being incorporated in the ECU 2, but may be configured as an integrated circuit such as an IC or ASIC integrated with the sensor 6 provided in the brake pedal device 4.

The eighth embodiment described above can also achieve the same effects as the first to seventh embodiments.

### Other Embodiments

The present disclosure is not limited to the embodiments described above, and can be modified as appropriate. The above-described embodiments are not independent of each other, and can be appropriately combined together except when the combination is obviously impossible. The constituent element(s) of each of the above embodiments is/are not necessarily essential unless it is specifically stated that the constituent element(s) is/are essential in the above embodiment, or unless the constituent element(s) is/are obviously essential in principle. A quantity, a value, an amount, a range, or the like referred to in the description of the embodiments described above is not necessarily limited to such a specific value, amount, range or the like unless it is specifically described as essential or understood as being essential in principle. Furthermore, a shape, positional relationship or the like of a structural element, which is referred to in the embodiments described above, is not limited to such a shape, positional relationship or the like, unless it is specifically described or obviously necessary to be limited in principle.

The control unit and the method thereof described in the present disclosure are realized by a dedicated computer provided by configuring a processor and a memory programmed to execute one or more functions embodied by a computer program. May be done. Alternatively, the controller and the method described in the present disclosure may be implemented by a special purpose computer configured as a processor with one or more special purpose hardware logic circuits. Alternatively, the controller and the method described in the present disclosure may be implemented by one or more special purpose computer, which is configured as a combination of a processor and a memory, which are programmed to perform one or more functions, and a processor which is configured with one or more hardware logic circuits. The computer programs may be stored, as instructions to be executed by a computer, in a tangible non-transitory computer-readable medium.

### Various Aspects of Present Disclosure

The present disclosure described above can be understood from the following features, for example.

### Aspect 1:

A signal processing device for processing a sensor signal of a brake pedal device (4) and used in a brake-by-wire system (1), wherein
the brake pedal device includes
   a support member (7) being attached to a vehicle,
   a pedal arm (8) configured to be rotatably provided around a predetermined axis (CL) relative to the support member, and to rotate in an opening direction when a driver's pedal force increases and rotates in a closing direction when the driver's pedal force decreases or is released,
   a spring mechanism (10) configured to apply a biasing force to the pedal arm as a reaction force against the driver's pedal force,
   a full-close stopper (9) configured to stop the pedal arm at a fully closed position where a rotation of the pedal arm in the closing direction is restricted when the driver's pedal force is not applied to the pedal arm, and
   a sensor (6) configured to output a sensor signal corresponding to an angle or a stroke amount of the pedal arm,
the signal processing device includes
   a behavior determination unit (16) configured to determine, based on the sensor signal, whether a bouncing behavior occurs after the pedal arm rotates in the closing direction and reaches the fully closed position,
   a filter circuit (17) configured to perform smoothing processing on the sensor signal in accordance with a filter constant to generate a control signal for braking the vehicle, the filter circuit generating the control signal with a greater degree of smoothing of the change in the sensor signal as the filter constant increases, and
   a filter constant setting unit (18) configured to set the filter constant when the behavior determination unit determines that the bouncing behavior occurs to a value larger than the filter constant when the behavior determination unit determines that the bouncing behavior does not occur.

### Aspect 2:

A signal processing device for processing a sensor signal of a brake pedal device (4) and used in a brake-by-wire system (1), wherein
the brake pedal device includes
   a support member (7) being attached to a vehicle,
   a pedal arm (8) configured to be rotatably provided around a predetermined axis (CL) relative to the support member, and to rotate in an opening direction when a driver's pedal force increases and rotates in a closing direction when the driver's pedal force decreases or is released,
   a spring mechanism (10) configured to apply a biasing force to the pedal arm as a reaction force against the driver's pedal force,
   a full-close stopper (9) configured to stop the pedal arm at a fully closed position where a rotation of the pedal arm in the closing direction is restricted when the driver's pedal force is not applied to the pedal arm, and
   a sensor (6) configured to output a sensor signal corresponding to an angle or a stroke amount of the pedal arm,
the signal processing device includes
   a behavior determination unit (16) configured to determine, based on the sensor signal, whether a bouncing behavior occurs after the pedal arm rotates in the closing direction and reaches the fully closed position, and
   a signal switching unit (20) configured to, when the behavior determination unit determines that the bouncing behavior occurs, switch and output a control signal for braking the vehicle to a signal value indicating that the pedal arm is in the fully closed position for a predetermined period of time.

### Aspect 3:

In the signal processing device according to aspect 1 or 2, the behavior determination unit calculates an operating speed of the pedal arm from a differential value of the sensor signal, and determines that the bouncing behavior occurs when the pedal arm rotates in the closing direction at a speed equal to or greater than a predetermined speed threshold (Th_v), or when the pedal arm reaches the fully closed position at a speed equal to or greater than the predetermined speed threshold.

### Aspect 4:

In the signal processing device according to any one of aspects 1 to 3, the behavior determination unit determines that the bouncing behavior occurs when a time during which the pedal arm stays at the fully closed position and at a position further in the closing direction than the fully closed position is shorter than a predetermined time threshold (Th_t).

### Aspect 5:

In the signal processing device according to any one of aspects 1 to 4, the behavior determination unit calculates an operating acceleration of the pedal arm from a second-order differential value of the sensor signal, and determines that the bouncing behavior occurs when an acceleration equal to or greater than a predetermined acceleration threshold (Th_a) occurs between the time when the pedal arm rotates in the closing direction and reaches the fully closed position.

### Aspect 6:

In the signal processing device according to aspect 5, the predetermined acceleration threshold is a constant value or a value that is uniquely determined according to an angle or a stroke amount of the pedal arm based on a characteristic of the spring mechanism and a mass of the pedal arm.

### Aspect 7:

In the signal processing device according to any one of aspects 1 to 6, the behavior determination unit determines that the bouncing behavior occurs when the pedal arm moves by a predetermined distance threshold (Th_d) or more in the closing direction from the fully closed position.

### Aspect 8:

In the signal processing device according to any one of aspects 1 to 7, the brake pedal device includes a load sensor (21) configured to detect whether the driver's pedal force is applied to the pedal arm, and
based on an output signal of the load sensor and the sensor signal, the behavior determination unit determines that the bouncing behavior occurs when the pedal arm rotates in the closing direction and reaches the fully closed position while the driver's pedal force is not being applied to the pedal arm.

### Aspect 9:

In the signal processing device according to aspect 1, the behavior determination unit determines a magnitude of the bouncing behavior based on the sensor signal, and
the filter constant setting unit sets the filter constant to a larger value as the bouncing behavior increases.

### Aspect 10:

In the signal processing device according to any one of aspects 1 to 9, the behavior determination unit determines a magnitude of the bouncing behavior based on the sensor signal, and
the filter constant setting unit increases the time from when the behavior determination unit sets the filter constant when it determines that the bouncing behavior occurs to when it returns to the filter constant when the behavior determination unit determines that the bouncing behavior does not occur, the larger the bouncing behavior is.

### Aspect 11:

In the signal processing device according to aspect 2, the behavior determination unit determines a magnitude of the bouncing behavior based on the sensor signal, and
the signal switching unit increases a predetermined time from when the control signal for braking the vehicle is switched to the signal value indicating that the pedal arm is in the fully closed position until when the behavior determination unit returns the control signal to the value when the bouncing behavior is determined not to occur, the larger the bouncing behavior.

What is claimed is:

1. A signal processing device for processing a sensor signal of a brake pedal device and used in a brake-by-wire system, wherein the brake pedal device includes
a support member being attached to a vehicle,
a pedal arm configured to be rotatably provided around a predetermined axis relative to the support member, and to rotate in an opening direction when a driver's pedal force increases and rotates in a closing direction when the driver's pedal force decreases or is released,
a spring mechanism configured to apply a biasing force to the pedal arm as a reaction force against the driver's pedal force,
a full-close stopper configured to stop the pedal arm at a fully closed position where a rotation of the pedal arm in the closing direction is restricted when the driver's pedal force is not applied to the pedal arm, and
a sensor configured to output a sensor signal corresponding to an angle or a stroke amount of the pedal arm,
the signal processing device, comprising:
at least one of (i) a circuit and (ii) a processor with a memory storing computer program code executable by the processor, the at least one of the circuit and the processor configured to cause the signal processing device to:
determine, based on the sensor signal, whether a bouncing behavior occurs after the pedal arm rotates in the closing direction and reaches the fully closed position,
perform smoothing processing on the sensor signal in accordance with a filter constant to generate a control signal for braking the vehicle, the control signal being with a greater degree of smoothing of a change in the sensor signal as the filter constant increases; and
set the filter constant when determining that the bouncing behavior occurs to a value larger than the filter constant when determining that the bouncing behavior does not occur.

2. A signal processing device for processing a sensor signal of a brake pedal device and used in a brake-by-wire system, wherein the brake pedal device includes
a support member being attached to a vehicle,
a pedal arm configured to be rotatably provided around a predetermined axis relative to the support member, and to rotate in an opening direction when a driver's pedal force increases and rotates in a closing direction when the driver's pedal force decreases or is released,
a spring mechanism configured to apply a biasing force to the pedal arm as a reaction force against the driver's pedal force,
a full-close stopper configured to stop the pedal arm at a fully closed position where a rotation of the pedal arm in the closing direction is restricted when the driver's pedal force is not applied to the pedal arm, and
a sensor configured to output a sensor signal corresponding to an angle or a stroke amount of the pedal arm,
the signal processing device, comprising:
at least one of (i) a circuit and (ii) a processor with a memory storing computer program code executable by the processor, the at least one of the circuit and the processor configured to cause the signal processing device to:
determine, based on the sensor signal, whether a bouncing behavior occurs after the pedal arm rotates in the closing direction and reaches the fully closed position, and
when determining that the bouncing behavior occurs, switch and output a control signal for braking the vehicle to a signal value indicating that the pedal arm is in the fully closed position for a predetermined period of time.

3. The signal processing device according to claim 1, wherein
the at least one of the circuit and the processor is configured to cause the signal processing device to
calculate an operating speed of the pedal arm from a differential value of the sensor signal, and
determine that the bouncing behavior occurs when the pedal arm rotates in the closing direction at a speed equal to or greater than a predetermined speed threshold, or when the pedal arm reaches the fully closed position at a speed equal to or greater than the predetermined speed threshold.

4. The signal processing device according to claim 1, wherein
the at least one of the circuit and the processor is configured to cause the signal processing device to
determine that the bouncing behavior occurs when a time during which the pedal arm stays at the fully closed position and at a position further in the closing direction than the fully closed position is shorter than a predetermined time threshold.

5. The signal processing device according to claim 1, wherein
the at least one of the circuit and the processor is configured to cause the signal processing device to
calculate an operating acceleration of the pedal arm from a second-order differential value of the sensor signal, and
determine that the bouncing behavior occurs when an acceleration equal to or greater than a predetermined acceleration threshold occurs between the time when the pedal arm rotates in the closing direction and reaches the fully closed position.

6. The signal processing device according to claim 5, wherein
the predetermined acceleration threshold is a constant value or a value that is uniquely determined according to an angle or a stroke amount of the pedal arm based on a characteristic of the spring mechanism and a mass of the pedal arm.

7. The signal processing device according to claim 1, wherein
the at least one of the circuit and the processor is configured to cause the signal processing device to
determine that the bouncing behavior occurs when the pedal arm moves by a predetermined distance threshold or more in the closing direction from the fully closed position.

8. The signal processing device according to claim 1, wherein
the brake pedal device includes a load sensor configured to detect whether the driver's pedal force is applied to the pedal arm, and
the at least one of the circuit and the processor is configured to cause the signal processing device to
based on an output signal of the load sensor and the sensor signal, determine that the bouncing behavior occurs when the pedal arm rotates in the closing direction and reaches the fully closed position while the driver's pedal force is not being applied to the pedal arm.

9. The signal processing device according to claim 1, wherein
the at least one of the circuit and the processor is configured to cause the signal processing device to
determine a magnitude of the bouncing behavior based on the sensor signal, and
set the filter constant to a larger value as the bouncing behavior increases.

10. The signal processing device according to claim 1, wherein
the at least one of the circuit and the processor is configured to cause the signal processing device to
determine a magnitude of the bouncing behavior based on the sensor signal, and
increase a time from when setting the filter constant when determining that the bouncing behavior occurs to when returning to the filter constant when determining that the bouncing behavior does not occur, the larger the bouncing behavior is.

11. The signal processing device according to claim 2, wherein
the at least one of the circuit and the processor is configured to cause the signal processing device to
determine a magnitude of the bouncing behavior based on the sensor signal, and
increase a predetermined time from when the control signal for braking the vehicle is switched to the signal value indicating that the pedal arm is in the fully closed position until when returning the control signal to the value when the bouncing behavior is determined not to occur, the larger the bouncing behavior.

12. The signal processing device according to claim 2, wherein
the at least one of the circuit and the processor is configured to cause the signal processing device to
calculate an operating speed of the pedal arm from a differential value of the sensor signal, and
determine that the bouncing behavior occurs when the pedal arm rotates in the closing direction at a speed equal to or greater than a predetermined speed threshold, or when the pedal arm reaches the fully closed position at a speed equal to or greater than the predetermined speed threshold.

13. The signal processing device according to claim 2, wherein
the at least one of the circuit and the processor is configured to cause the signal processing device to
determine that the bouncing behavior occurs when a time during which the pedal arm stays at the fully closed position and at a position further in the closing direction than the fully closed position is shorter than a predetermined time threshold.

14. A signal processing device for processing a sensor signal of a brake pedal device and used in a brake-by-wire system, wherein the brake pedal device includes
a support member being attached to a vehicle,
a pedal arm configured to be rotatably provided around a predetermined axis relative to the support member, and to rotate in an opening direction when a driver's pedal force increases and rotates in a closing direction when the driver's pedal force decreases or is released,
a spring mechanism configured to apply a biasing force to the pedal arm as a reaction force against the driver's pedal force,
a full-close stopper configured to stop the pedal arm at a fully closed position where a rotation of the pedal arm in the closing direction is restricted when the driver's pedal force is not applied to the pedal arm, and
a sensor configured to output a sensor signal corresponding to an angle or a stroke amount of the pedal arm,
the signal processing device, comprising:
a behavior determination unit configured to determine, based on the sensor signal, whether a bouncing behavior occurs after the pedal arm rotates in the closing direction and reaches the fully closed position,
a filter circuit configured to perform smoothing processing on the sensor signal in accordance with a filter constant to generate a control signal for braking the vehicle, the filter circuit generating the control signal with a greater degree of smoothing of a change in the sensor signal as the filter constant increases; and
a filter constant setting unit configured to set the filter constant when the behavior determination unit determines that the bouncing behavior occurs to a value larger than the filter constant when the behavior determination unit determines that the bouncing behavior does not occur.

15. A signal processing device for processing a sensor signal of a brake pedal device and used in a brake-by-wire system, wherein the brake pedal device includes
a support member being attached to a vehicle,
a pedal arm configured to be rotatably provided around a predetermined axis relative to the support member, and to rotate in an opening direction when a driver's pedal force increases and rotates in a closing direction when the driver's pedal force decreases or is released,
a spring mechanism configured to apply a biasing force to the pedal arm as a reaction force against the driver's pedal force,
a full-close stopper configured to stop the pedal arm at a fully closed position where a rotation of the pedal arm in the closing direction is restricted when the driver's pedal force is not applied to the pedal arm, and
a sensor configured to output a sensor signal corresponding to an angle or a stroke amount of the pedal arm,
the signal processing device, comprising:
a behavior determination unit configured to determine, based on the sensor signal, whether a bouncing behavior occurs after the pedal arm rotates in the closing direction and reaches the fully closed position, and
a signal switching unit configured to, when the behavior determination unit determines that the bouncing behavior occurs, switch and output a control signal for braking the vehicle to a signal value indicating that the pedal arm is in the fully closed position for a predetermined period of time.

16. The signal processing device according to claim 14, wherein
the behavior determination unit calculates an operating speed of the pedal arm from a differential value of the sensor signal, and determines that the bouncing behavior occurs when the pedal arm rotates in the closing direction at a speed equal to or greater than a predetermined speed threshold, or when the pedal arm reaches the fully closed position at a speed equal to or greater than the predetermined speed threshold.

17. The signal processing device according to claim 14, wherein
the behavior determination unit determines that the bouncing behavior occurs when a time during which the pedal arm stays at the fully closed position and at a position further in the closing direction than the fully closed position is shorter than a predetermined time threshold.

18. The signal processing device according to claim 15, wherein
the behavior determination unit calculates an operating speed of the pedal arm from a differential value of the sensor signal, and determines that the bouncing behavior occurs when the pedal arm rotates in the closing direction at a speed equal to or greater than a predetermined speed threshold, or when the pedal arm reaches the fully closed position at a speed equal to or greater than the predetermined speed threshold.

19. The signal processing device according to claim 15, wherein
the behavior determination unit determines that the bouncing behavior occurs when a time during which the pedal arm stays at the fully closed position and at a position further in the closing direction than the fully closed position is shorter than a predetermined time threshold.
